(19) United States
(12) Patent Application Publication
(10) Pub. No.: US 2025/0142200 A1
(43) Pub. Date: May 1, 2025

(54) VIDEO CONTENT PROCESSING BASED ON FACIAL RECOGNITION AND POSE TRACKING MODELING

(71) Applicant: SHURE ACQUISITION HOLDINGS, INC., Niles, IL (US)

(72) Inventors: Andrew Pieper, San Antonio, TX (US); Daniel Law, Glencoe, IL (US); Bibo Gao, Buffalo Grove, IL (US)

(21) Appl. No.: 18/934,771

(22) Filed: Nov. 1, 2024

Related U.S. Application Data
(60) Provisional application No. 63/595,026, filed on Nov. 1, 2023.

(51) Int. Cl. H04N 23/611; G06V 10/44; G06V 20/40; G06V 40/16; H04N 23/695

(52) U.S. Cl. CPC H04N 23/611; G06V 10/454; G06V 20/46; G06V 40/172; H04N 23/695

(57) ABSTRACT

Techniques are disclosed herein for providing video content processing based on facial recognition and pose tracking modeling. Examples may include receiving video data captured by at least one video capture device located within a video environment, extracting an image feature set from the video data, inputting the image feature set to a facial recognition model to generate a facial feature set for a facial identifier associated with a target of interest in the video environment, inputting the facial feature set to a pose tracking model to generate a pose tracking feature set for the facial identifier, augmenting the facial feature set with the pose tracking feature set to generate an augmented feature set for the facial identifier, and outputting location information for the facial identifier based at least in part on the augmented feature set.

### CROSS REFERENCE TO RELATED APPLICATIONS

This application claims the benefit of U.S. Provisional Patent Application No. 63/595,026, titled “VIDEO CONTENT PROCESSING BASED ON FACIAL RECOGNITION AND POSE TRACKING MODELING,” and filed on Nov. 1, 2023, the entirety of which is hereby incorporated by reference.

### TECHNICAL FIELD

Embodiments of the present disclosure relate generally to video processing and, more particularly, to systems configured to process video content using machine learning.

### BACKGROUND

A video system may capture, process, and/or transmit video data captured by a video camera in a video environment. However, existing techniques for capturing, processing, and/or transmitting video associated with a video environment are prone to inaccuracies and/or inefficiencies.

### BRIEF SUMMARY

Various embodiments of the present disclosure are directed to apparatuses, systems, methods, and computer readable media for providing video content processing based on facial recognition and pose tracking modeling. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example video processing system configured to execute audio/video (AV) processing operations related to video events in accordance with one or more embodiments disclosed herein;

FIG. 2 illustrates an example AV processing apparatus configured in accordance with one or more embodiments disclosed herein;

FIG. 3 illustrates an example network system in accordance with one or more embodiments disclosed herein;

FIG. 4 illustrates an example facial recognition and pose tracking architecture in accordance with one or more embodiments disclosed herein;

FIG. 5 illustrates an example feature augmentation architecture in accordance with one or more embodiments disclosed herein;

FIG. 6 illustrates an example video optimization architecture in accordance with one or more embodiments disclosed herein;

FIG. 7 illustrates an example facial recognition model in accordance with one or more embodiments disclosed herein;

FIG. 8 illustrates an example video frame in accordance with one or more embodiments disclosed herein;

FIG. 9 illustrates an example video environment in accordance with one or more embodiments disclosed herein; and

FIG. 10 illustrates an example method for providing video content processing based on facial recognition and pose tracking modeling in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

An audio video (AV) conferencing system may include one or more video cameras to capture video data in a video environment. The captured video data may be transmitted between devices in the video environment and/or another environment via a network. For example, a remote hub may receive and process the captured video data from the video cameras. The remote hub may also transmit the processed video data to one or more display devices in the video environment and/or another environment via a network. In certain scenarios, a video environment may be a conference room environment with one or more video cameras. In such a scenario, a traditional AV conferencing system may execute a person identification model using an entire image set related to video data. The traditional AV conferencing system may then begin processing each person detected in the image set to provide pose information for each detected person. However, with traditional AV conferencing systems, inefficient network latencies and/or bandwidth utilization for transmitting the video data may occur by utilizing an entire image set related to video data for person identification modeling. Additionally, inefficient and/or unnecessary video processing by the video camera may additionally or alternatively occur by utilizing an entire image set related to video data for person identification modeling.

Various examples disclosed herein provide video content processing based on facial recognition and pose tracking modeling. The pose tracking modeling may be informed using information provided by the facial recognition modeling. Additionally, output from the pose tracking modeling may be utilized to anonymously track a target of interest (e.g., a person or other entity) in video content and/or in a field of view (FOV) of a video capture device.

### Example Video Processing Systems and Methods

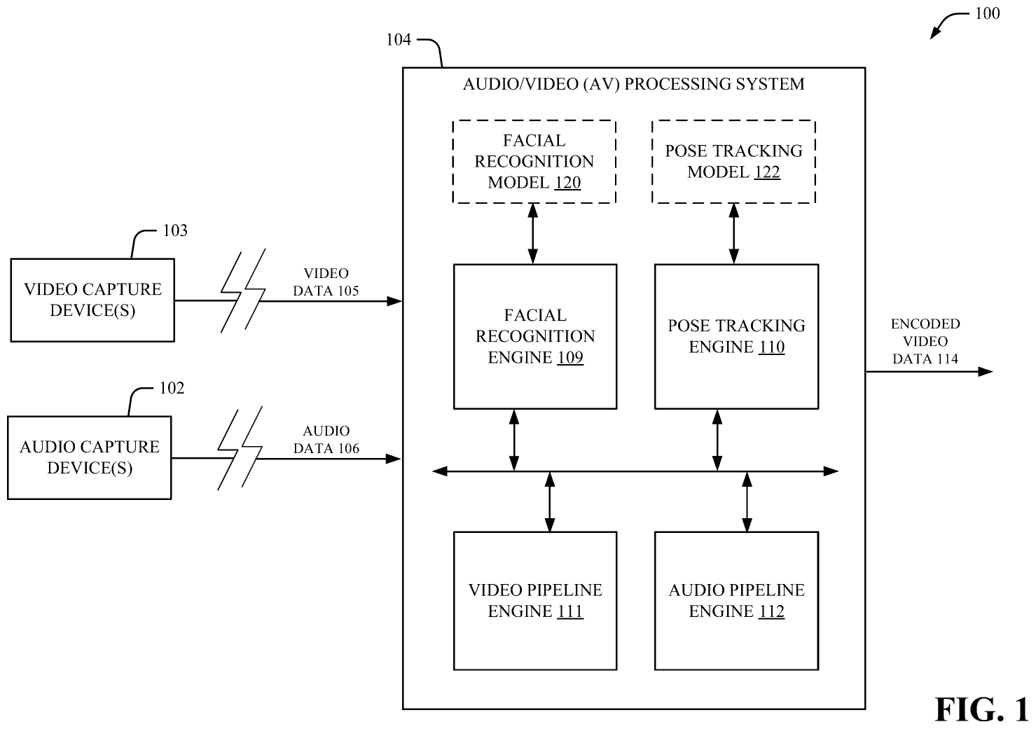

FIG. 1 illustrates a video processing system 100 that is configured to provide video content processing based on facial recognition and pose tracking modeling, according to embodiments of the present disclosure. For example, the video processing system 100 provides real-time tracking of a target of interest in video content related to a video environment. The video processing system 100 may be, for example, a video environment system, a conferencing system (e.g., a conference audio system, a video conferencing system, an audio video (AV) conferencing system, a digital conference system, etc.), a lecture hall system, a classroom system, a live event system, an automobile advanced driver assistance system (ADAS), a digital media content workstation, a broadcasting system, an augmented reality system, a virtual reality system, a gaming system, an online gaming system, or another type of video system. Additionally, the video processing system 100 may be implemented as a video processing apparatus and/or as software that is configured for execution on a network device, a video capture device, a smartphone, a laptop, a personal computer, a digital conference system, a wireless conference unit, a video workstation device, or another device. The video processing system 100 disclosed herein may additionally or alternatively be integrated into a virtual video processing system (e.g., video processing via virtual processors or virtual machines) with other audio and/or digital signal processing.

The video processing system 100 may be utilized for various types of applications such as, but not limited to: person face and body tracking, individual framing for video conferencing, passing of image information such as closely cropped faces for artificial intelligence (AI) applications, person localization within a video environment for use with an array microphone, etc.

By providing video content processing based on facial recognition and pose tracking modeling, the video processing system 100 may provide various improvements related to video processing such as, for example: minimizing network latency for transmitting video data over a network, minimizing bandwidth utilization for transmitting video data over a network, reducing a number of computing resources for processing video by a video capture device, and/or improving power consumption for processing video by a video capture device. The video processing system 100 may also be adapted to produce improved video signals for a video environment. Additionally or alternatively, the video processing system 100 may be adapted to produce improved video signals with reduced noise, reduced reverberation, improved source separation, and/or a reduction in other undesirable audio artifacts. A video environment may be an indoor environment, an outdoor environment, an entertainment environment, a room, a classroom, a lecture hall, a performance hall, a broadcasting environment, a sports stadium or arena, a virtual environment, an automobile environment, or another type of video environment.

In some examples, the video processing system 100 may enable enhancement of generation video enabled products or other types of video content applications. In some examples, the video processing system 100 may utilize a multi-modal use of different face detectors enhanced with a pose detector to provide accurate and robust person tracking in real-time for use on embedded devices and/or other AV conferencing systems. Additionally, by informing pose detection modeling with the tracked locations of each person in an image set, the video processing system 100 may enable higher accuracy and/or faster performance for video processing utilizing pose detection modeling.

In some examples, pose tracking modeling provided by the video processing system 100 may be performed with improved processing speed and/or a reduced number of computing resources by utilizing information from facial recognition modeling to optimize the pose tracking modeling. Moreover, by utilizing video content processing based on facial recognition and pose tracking modeling, the video processing system 100 may minimize network latency and/or bandwidth utilization for transmitting video data. For example, by performing facial recognition and pose tracking modeling on edge devices, the video processing system 100 may reduce network bandwidth by transmitting modeling results along with extracted video data rather than mere transmittal of unprocessed video data. In some examples, the video processing system 100 may additionally or alternatively improve efficiency and/or quality of video processing by a video capture device. For example, improved video output related to a target of interest in video content and/or in a FOV of a video capture device may be provided via the improved pose tracking associated with the video processing system 100.

In some examples, the video processing system 100 may provide video streams for rendering via one or more display devices. In some examples, a display device may receive a video stream via a physical interface protocol such as a universal serial bus (USB) communication protocols or another type of communication protocol. In some examples, a display device may receive a video stream via a network communication protocol such as an Internet Protocol (IP), IP over Ethernet (IPoE), or other network communication protocol. In some examples, a display device may be a virtual camera or another type of virtual device.

The video processing system 100 includes one or more video capture devices 103. The one or more video capture devices 103 may respectively be devices configured to capture video related to the one or more sound sources. The one or more video capture devices 103 may include one or more sensors configured for capturing video by converting light into one or more electrical signals. The video captured by the one or more video capture devices 103 may also be converted into video data 105. In an example, the one or more video capture devices 103 are one or more video cameras. In some examples, the one or more video capture devices 103 includes a plurality of video capture devices to enable tracking of a target of interest (e.g., a person or other entity) across multiple video capture devices in a video environment.

In some examples, the video processing system 100 additionally includes one or more audio capture devices 102. The one or more audio capture devices 102 may respectively be devices configured to capture audio from one or more sound sources. The one or more audio capture devices 102 may include one or more sensors configured for capturing audio by converting sound into one or more electrical signals. The audio captured by the one or more audio capture devices 102 may also be converted into audio data 106. The audio data 106 may be a digital audio data or, alternatively, analog audio data, related to the one or more electrical signals. In some examples, the audio data 106 may be beamformed audio data.

In an example, the one or more audio capture devices 102 are one or more microphones arrays. For example, the one or more audio capture devices 102 may correspond to one or more array microphones, one or more beamformed lobes of an array microphone, one or more linear array microphones, one or more ceiling array microphones, one or more table array microphones, or another type of array microphone. In alternate examples, the one or more audio capture devices 102 are another type of capture device such as, but not limited to, one or more condenser microphones, one or more micro-electromechanical systems (MEMS) microphones, one or more dynamic microphones, one or more piezoelectric microphones, one or more virtual microphones, one or more network microphones, one or more ribbon microphones, and/or another type of microphone configured to capture audio. It is to be appreciated that, in certain examples, the one or more audio capture devices 102 may additionally or alternatively include one or more infrared capture devices, one or more sensor devices, one or more video capture devices (e.g., one or more video capture devices 103), and/or one or more other types of audio capture devices.

The one or more video capture devices 103 and/or the one or more audio capture devices 102 may be positioned within a particular video environment. In some examples, the video data 105 includes video frames related to a speaker associated with the audio data 106. In some examples, the one or more video capture devices 103 and the one or more audio capture devices 102 may be integrated together in one or more capture devices.

The video processing system 100 also comprises an audio/video (AV) processing system 104. The AV processing system 104 may be configured to perform one or more video processes and/or one or more audio processes with respect to the video data 105 and/or the audio data 106 to provide encoded video data 114. The AV processing system 104 depicted in FIG. 1 includes a facial recognition engine 109, a pose tracking engine 110, a video pipeline engine 111, and/or an audio pipeline engine 112.

The facial recognition engine 109 utilizes one or more facial recognition techniques with respect to the video data 105 received from the one or more video capture devices 103 to identify one or more faces in the video data 105. In some examples, the facial recognition engine 109 may extract an image feature set from the video data 105. Additionally, the facial recognition engine 109 may input the image feature set to a facial recognition model 120 to generate a facial feature set for a facial identifier associated with a target of interest in the video data 105. The target of interest may be a detected person, a previously detected person, a person associated with a digital identifier, a person related to speech (e.g., real-time speech), etc. In some examples, the term “facial recognition” refers to recognition of a particular target of interest (e.g., a specific person or an identity of a person). In some examples, the term “facial recognition” refers to detection of a target of interest without a correlation to a specific person or identity of a person.

In some examples, the facial recognition model 120 may be configured as a neural network model, a deep learning model, a convolutional neural network model, and/or another type of machine learning model. In some examples, the facial recognition model 120 may utilize eye gaze estimation modeling that provides eye tracking with respect to a face in a video frame, active speaker recognition modeling that predicts an active speaker in a video frame, and/or one or more other types of modeling techniques to enable detection of one or more faces in the video data 105.

In some examples, the facial recognition model 120 may include a modified YuNet architecture associated with a feature extraction portion and a tiny feature pyramid network (TFPN) portion for face detection, head detection, and/or body detection. In some examples, the feature extraction portion may extract the image feature set from the video data 105. The feature extraction portion may include one or more machine learning stages such as, but not limited to: a convolution layer stage, a depthwise convolution stage, a maxpooling stage, one or more rectifier linear units, and/or another type of machine learning stage. In some examples, one or more machine learning stages of the feature extraction portion may be communicatively coupled to the TFPN portion.

The TFPN portion may provide facial recognition output associated with depthwise separable convolution and/or a feature pyramid network based on output provided by one or more machine learning stages of the feature extraction portion. The TFPN portion may additionally perform upsampling with respect to output provided by one or more machine learning stages of the feature extraction portion to enable improved facial recognition output. In some examples, the TFPN portion may provide a prediction associated with the facial feature set. In some examples, the TFPN portion may predict values of a location associated with the facial feature set.

In some examples, the modified YuNet architecture associated with the facial recognition model 120 may include a modified width and/or a modified depth as compared to a depthwise separable convolution architecture of a YuNet architecture. Additionally or alternatively, a channel size and/or a number of features for the image feature set extracted from the video data 105 may be configured to provide improved accuracy associated with the facial feature set. In some examples, a channel size of a first machine learning stage of the feature extraction portion may be smaller than three to match an input channel size. By configuring the channel size of the first machine learning stage to match the input channel size, an amount of preprocessing of one or more images associated with the video data 105 may be reduced and/or an amount of computational time for providing one or more model inferences (e.g., the facial feature set) via the facial recognition model 120 may be reduced.

In some examples, a number of machine learning stages for the modified YuNet architecture associated with the facial recognition model 120 may be greater than five to provide to provide improved accuracy associated with the facial feature set. In some examples, a channel size and/or a number of features extracted from the video data 105 for one or more other machine learning stages of the feature extraction portion (e.g., one or more other machine learning stages different than the first machine learning stage) may be greater than 16 to provide improved accuracy associated with the facial feature set. In some examples, one or more other machine learning stages of the feature extraction portion may include an input layer size that is greater than 16 and/or an output layer size that is greater than 32. In some examples, a number of down sampling and/or a number of up sampling instances for the modified YuNet architecture associated with the facial recognition model 120 may be smaller than five to enable a reduced input image size and/or to match a size ratio of an input image for reducing an inference time for the facial recognition model 120.

The image feature set may include one or more image features related to the video data 105 such as, but not limited to: pixel information, pixel intensity, color information, color histograms, edge detection information, shape descriptors, texture descriptors, and/or other image information. In some examples, the image feature set may be included in an image feature descriptor vector related to the video data 105. In some examples, the image feature descriptor vector may augment the image feature set with one or more features provided by a secondary feature extraction model related to reidentification for the target of interest in the video data 105. The one or more features provided by the secondary feature extraction model may be utilized to improve matching with respect to one or more image features of the image feature set and/or between multiple video frames via one or more distance metrics. The one or more distance metrics may include a minimized cosine distance metric or another type of distance metric.

The facial feature set may include one or more facial recognition inferences with respect to the video data 105. In some examples, the facial feature set may include one or more facial features such as, but not limited to: a facial identifier that corresponds to a tracked face, bounding box coordinates of a tracked face (e.g., left, right, top and bottom coordinates), a set of keypoints corresponding to one or more particular facial attributes (e.g., nose, eyes, mouth, etc.), a match count corresponding to a total amount of times a face has been matched over time, last seen image information corresponding to extracted imagery of a last time a tracked face has been matched, last matched frame information corresponding to a video frame number of the last time the tracked face was matched, inferred three-dimensional (3D) locations of points in the video environment, depth estimation information related to a 3D representation associated with one or more video frames of the video data 105, and/or other facial information. In some examples, the facial feature set may be included in a facial feature descriptor vector provided by the facial recognition model 120. The facial feature descriptor vector may include facial features from one or more video frames. In some examples, the facial feature descriptor vector may include facial features aggregated from two or more video frames.

The pose tracking engine 110 may utilize information provided by the facial recognition engine 109 to estimate a pose of the target of interest in the video data 105. In some examples, the pose tracking engine 110 may input the facial feature set to a pose tracking model 122 to generate a pose tracking feature set for the facial identifier. In some examples, the pose tracking model 122 may be configured as a neural network model, a deep learning model, a convolutional neural network model, and/or another type of machine learning model. In some examples, the pose tracking engine 110 may augment the facial feature set with the pose tracking feature set to generate an augmented feature set for the facial identifier.

The pose tracking feature set may include one or more pose tracking inferences with respect to the video data 105. In some examples, the pose tracking feature set may include one or more pose tracking features such as, but not limited to: bounding box coordinates of a tracked body (e.g., left, right, top and bottom coordinates), head pose features, head pose angles, body pose features, body pose angles, last frame information corresponding to a last video frame that the pose information was last updated, color histogram information, and/or other pose tracking information. In some examples, the pose tracking feature set may be included in a pose tracking feature descriptor vector provided by the pose tracking model 122.

The video pipeline engine 111 may utilize information provided by the pose tracking engine 110 to generate encoded video data 114. The encoded video data 114 may be an encoded version of the video data 105. In some examples, the video pipeline engine 111 may determine and/or output location information for the facial identifier based at least in part on the augmented feature set. The video pipeline engine 111 may additionally or alternatively determine and/or output other information for the facial identifier based at least in part on the augmented feature set. For example, the other information for the facial identifier may include an identity vector (e.g., identity embedding) for the facial identifier. The identity vector may include at least a portion of the augmented feature set to enable identification and/or tracking of the facial identifier.

In some examples, the video pipeline engine 111 may utilize the location information and/or the other information (e.g., the identity vector) for the facial identifier for one or more video processing applications such as, but not limited to: individual framing for video conferencing, generating input data (e.g., a cropped face) for an AI model, steering an array microphone in the video environment, providing audio source separation in the video environment, selecting an optimal video capture device in the video environment, creating a 3D model of the video environment, etc. In some examples, the video pipeline engine 111 may utilize the location information and/or the other information (e.g., the identity vector) for the facial identifier to enable tracking across multiple video capture devices 103. In some examples, the video pipeline engine 111 may perform source separation for audio data (e.g., the audio data 106) related to the video data 105 based on the location information and/or the other information (e.g., the identity vector) for the facial identifier. The source separation may identify a person associated with the facial identifier as a speaker. In some examples, further audio processing (e.g., denoising, dereverberation, audio filtering, and/or other audio processing) may be applied to the audio data associated with the source separation to further enhance quality of the audio data. In some examples, the video pipeline engine 111 may compare the augmented feature set to a predetermined representation of the target of interest via normalized correlation matching to generate a similarity score for the augmented feature set. Additionally, the video pipeline engine 111 may output the location information based at least in part on the similarity score.

In some examples, the video pipeline engine 111 transmits control data (e.g., one or more control signals) to the one or more video capture devices 103 to configure and/or control the one or more video capture devices 103. For example, the control data may be utilized to control and/or configure one or more portions of the one or more video capture devices 103. In some examples, the control data may include one or more configuration parameters (e.g., a configuration parameter set) for the one or more video capture devices 103 such as, but not limited to one or more: camera settings, camera selection, camera focus direction, pan, zoom, crop, microphone array settings, beam steering settings, video encoding settings, video frame transmission settings, video frame size, frame rate, color depth settings, resolution format settings, and/or another type of configuration parameter for the one or more video capture devices 103.

In some examples, the video pipeline engine 111 may configure the control data based on the location information and/or the other information (e.g., the identity vector) for the facial identifier. In some examples, the video pipeline engine 111 may modify video framing of at least one video capture device 103 based on the location information and/or the other information (e.g., the identity vector) for the facial identifier. Modification of the video framing may alter a position of visual data associated with the facial identifier in one or more video frames. In some examples, the video pipeline engine 111 may utilize the control data to modify the video framing of at least one video capture device 103. In some examples, the video pipeline engine 111 may utilize the control data to steer a microphone array beam for the one or more audio capture devices 102 and/or the one or more video capture devices 103.

In some examples, the control data may enable or disable one or more functionalities associated with the one or more video capture devices 103. For instance, the control data may include one or more control signals and/or configuration data to enable or disable one or more video processing tasks. A video processing task may include camera data acquisition, video encoding/decoding, video machine learning modeling, or another type of video processing task. In some examples, the control data may be additionally or alternatively utilized to: initiate feature extraction with respect to video data, configure parameters or types of features to be extracted, etc.

In some examples, the video pipeline engine 111 may generate input data for a machine learning model based on the location information and/or the other information (e.g., the identity vector) for the facial identifier. For example, the video pipeline engine 111 may provide input data associated with a cropped face (e.g., a cropped face associated with the facial identifier) to a machine learning model associated with a video pipeline and/or the one or more video capture devices 103. The machine learning model may be a neural network model, a deep learning model, a convolutional neural network model, and/or another type of machine learning model. In some examples, the machine learning model is a video machine learning model. In some examples, the machine learning model may generate metadata associated with the one or more video capture devices 103 to enable one or more inferences with respect to video data (e.g., the video data 105) provided by the one or more video capture devices 103.

In some examples, the metadata may be associated an average brightness or other quality determinations for a video frame, provide a group eye gaze prediction related to video frames, motion detection or proximity of a person in a video environment based on sensor data provided by one or more sensors of the one or more video capture devices 103, and/or other metadata. The sensor data may include motion sensor data, proximity sensor data, radar sensor data, LiDAR sensor data, time-of-flight (TOF) sensor data, and/or other sensor data to facilitate detection of a person or object in the video environment. In some examples, the metadata may be related to events with respect to video data.

In some examples, the machine learning model may be a head pose estimation model that computes a rotational matrix of a detected human face, an eye gaze estimation model that provides eye tracking with respect to a face in a video frame, a person detection model that detects one or more people in a video frame, an identity detection model that predicts an identity of one or more people in a video frame, an active speaker recognition model that predicts an active speaker in a video frame, an emotion detection model that predicts a type of emotion related to one or more people in a video frame, a sentiment model that predicts a type of sentiment related to one or more people in a video frame, a noise level prediction model that predicts a degree of noise related to a video frame, a speech detection model that detects speech audio related to a video frame, an audio event model that detects certain types of audio events (e.g., clapping, snapping, whispering, etc.) related to a video frame, a sound source model that classifies a type of sound associated with a sound source related to a video frame, a facial similarity model that determines accuracy metrics related to video data, a Kalman filter model that provides movement predictions for a target of interest related to an augmented feature set, and/or another type of machine learning model.

In some examples, the video pipeline engine 111 may select a particular video capture device 103 in the video environment for outputting a video stream associated with the facial identifier based on the location information and/or the other information (e.g., the identity vector) for the facial identifier. For example, the control data may include device selection data and/or device configuration data. The device selection data may include a video capture device identifier that corresponds to a video capture device 103 to be selected for operation in the video environment. The device configuration data may include one or more configuration parameters for one or more video capture devices 103. For example, the device configuration data may include one or more: camera settings, exposure, white balance, color temperature, camera selection, camera mode selection, camera focus direction, pan, zoom, crop, microphone selection, microphone array settings, beam steering settings, speech separation, video encoding settings, video frame transmission settings, video frame size, frame rate, color depth settings, resolution format settings, machine learning model settings, metadata selection settings, optical character recognition (OCR) settings, and/or another type of configuration parameter for the one or more video capture devices 103. In some examples, the device selection data may select an optimal video capture device 103 for a focus target. In some examples, the device configuration data may control a video capture device 103 and/or a related video stream from a selected video capture device identified in the device selection data.

In some examples, the video pipeline engine 111 may generate a 3D model of the video environment based on the location information and/or the other information (e.g., the identity vector) for the facial identifier. The 3D model may include 3D model data associated with visual attributes of the video environment. The 3D model data may include data related to 3D positions, viewing directions, color data, density data, camera pose data, and/or other visual attributes of the audio environment. In some example, the 3D model may include point cloud locations, voxel grid locations, mesh locations, or other 3D representative locations of the video environment.

In some examples, the video pipeline engine 111 outputs the encoded video data 114 to a network device. The network device may be a network switch, a user device, a display device, an edge device, or another type of device communicatively coupled to the video processing system 100 via a network. The network may be a communication network or any suitable network or combination of networks that supports any appropriate protocol suitable for communication of the encoded video data 114 to and from devices. For example, the network may utilize a network communication protocol such as IP, IPoE, or other network communication protocol to transmit the encoded video data 114 via IP datagrams. In some examples, the network may transmit the encoded video data 114 via one or more network layers such as a data link layer. In some examples, the encoded video data 114 may be encapsulated according to a network communication protocol to provide encapsulated video data packets. In some examples, the network is implemented as the Internet, a wireless network, a wired network (e.g., Ethernet), a local area network (LAN), a Wide Area Network (WANs), Bluetooth, Near Field Communication (NFC), or any other type of network that provides communications between one or more components of a network architecture.

Accordingly, the AV processing system 104 may provide improved video processing as compared to traditional video processing techniques. The AV processing system 104 may additionally or alternatively provide improved audio for the video environment. For example, the encoded video data 114 may be provided with improved accuracy of localization of a sound source in the video environment. The encoded video data 114 may be additionally or alternatively provided with improved audio signals with reduced noise, reverberation, and/or other undesirable audio artifacts even in view of exacting video latency requirements for the encoded video data 114. For example, the AV processing system 104 may remove or suppress undesirable noise for predefined noise locations in the video environment to provide the encoded video data 114.

The AV processing system 104 may also employ fewer computing resources when compared to traditional video processing systems that are used for video processing. Additionally or alternatively, the AV processing system 104 may be configured to deploy a smaller number of memory resources allocated to video processing, beamforming, source separation, denoising, dereverberation, and/or other audio processing for the encoded video data 114. In some examples, the AV processing system 104 may be configured to improve processing speed of video processing operations, beamforming operations, source separation operations, denoising operations, dereverberation operations, and/or audio filtering operations. These improvements may enable an improved AV processing systems to be deployed with respect to cameras, microphones or other hardware/software configurations where processing and memory resources are limited, and/or where processing speed and efficiency is important.

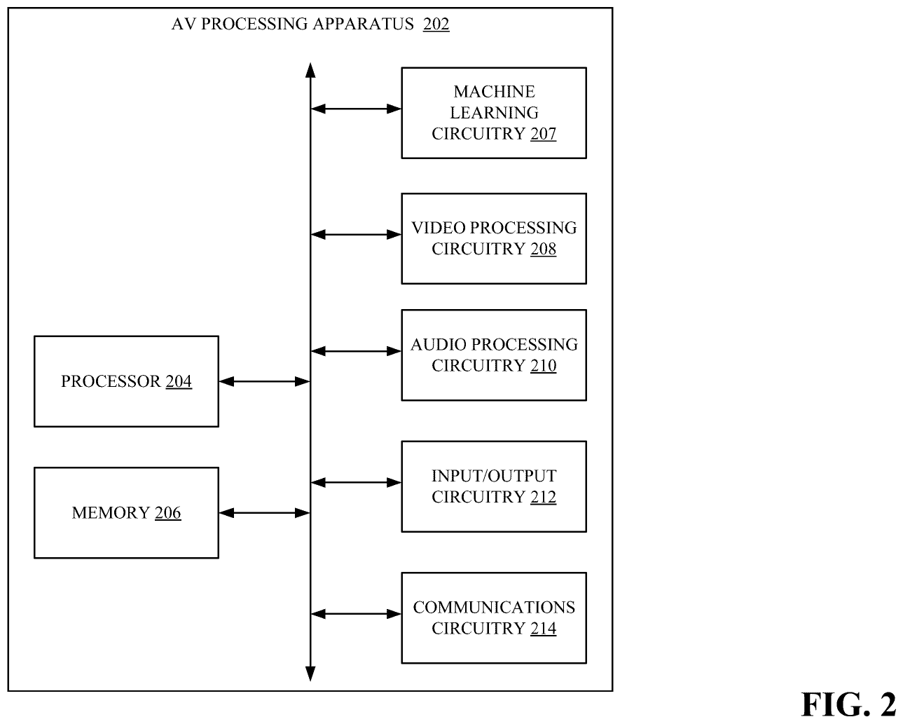

FIG. 2 illustrates an example AV processing apparatus 202 configured in accordance with one or more embodiments of the present disclosure. The AV processing apparatus 202 may be configured to perform one or more techniques described in FIG. 1 and/or one or more other techniques described herein.

The AV processing apparatus 202 may be a computing system communicatively coupled with one or more circuit modules related to video processing and/or audio processing. The AV processing apparatus 202 may comprise or otherwise be in communication with a processor 204, a memory 206, machine learning circuitry 207, video processing circuitry 208, audio processing circuitry 210, input/output circuitry 212, and/or communications circuitry 214. In some examples, the processor 204 (which may comprise multiple or co-processors or any other processing circuitry associated with the processor) may be in communication with the memory 206.

The memory 206 may comprise non-transitory memory circuitry and may comprise one or more volatile and/or non-volatile memories. In some examples, the memory 206 may be an electronic storage device (e.g., a computer readable storage medium) configured to store data that may be retrievable by the processor 204. In some examples, the data stored in the memory 206 may comprise video data, audio data, stereo audio signal data, mono audio signal data, radio frequency signal data, image features, audio features, video features, machine learning data, facial recognition data, pose tracking data, or the like, for enabling the AV processing apparatus 202 to carry out various functions or methods in accordance with embodiments of the present disclosure, described herein.

In some examples, the processor 204 may be embodied in a number of different ways. For example, the processor 204 may be embodied as one or more of various hardware processing means such as a central processing unit (CPU), a microprocessor, a coprocessor, a DSP, a field programmable gate array (FPGA), a neural processing unit (NPU), a graphics processing unit (GPU), a system on chip (SoC), a cloud server processing element, a controller, or a processing element with or without an accompanying DSP. The processor 204 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 204 may comprise one or more processing cores configured to perform independently. A multi-core processor may enable multiprocessing within a single physical package. Additionally or alternatively, the processor 204 may comprise one or more processors configured in tandem via a bus to enable independent execution of instructions, pipelining, and/or multithreading.

In some examples, the processor 204 may be configured to execute instructions, such as computer program code or instructions, stored in the memory 206 or otherwise accessible to the processor 204. Alternatively or additionally, the processor 204 may be configured to execute hard-coded functionality. As such, whether configured by hardware or software instructions, or by a combination thereof, the processor 204 may represent a computing entity (e.g., physically embodied in circuitry) configured to perform operations according to an embodiment of the present disclosure described herein. For example, when the processor 204 is embodied as an CPU, DSP, ARM, FPGA, ASIC, or similar, the processor may be configured as hardware for conducting the operations of an embodiment of the disclosure. Alternatively, when the processor 204 is embodied to execute software or computer program instructions, the instructions may specifically configure the processor 204 to perform the algorithms and/or operations described herein when the instructions are executed. However, in some examples, the processor 204 may be a processor of a device specifically configured to employ an embodiment of the present disclosure by further configuration of the processor using instructions for performing the algorithms and/or operations described herein. The processor 204 may further comprise a clock, an arithmetic logic unit (ALU) and logic gates configured to support operation of the processor 204, among other things.

In one or more examples, the AV processing apparatus 202 includes the machine learning circuitry 207. The machine learning circuitry 207 may be any means embodied in either hardware or a combination of hardware and software that is configured to perform one or more machine learning functions disclosed herein related to the facial recognition engine 109, the pose tracking engine 110, and/or the video pipeline engine 111. For example, the machine learning circuitry 207 may be any means embodied in either hardware or a combination of hardware and software that is configured to perform one or more machine learning functions disclosed herein related to the facial recognition model 120, the pose tracking model 122, and/or one or more other models disclosed herein. In one or more examples, the AV processing apparatus 202 includes the video processing circuitry 208. The video processing circuitry 208 may be any means embodied in either hardware or a combination of hardware and software that is configured to perform one or more functions disclosed herein related to the video scoring engine 109, the device control engine 110, and/or the video pipeline engine 111. For example, the video processing circuitry 208 may be any means embodied in either hardware or a combination of hardware and software that is configured to perform one or more functions disclosed herein related to processing of the metadata 101 received from the one or more machine learning models 120 and/or processing of the video data 105 received from the one or more video capture devices 103. In one or more examples, the AV processing apparatus 202 includes the audio processing circuitry 210. The audio processing circuitry 210 may be any means embodied in either hardware or a combination of hardware and software that is configured to perform one or more functions disclosed herein related to the audio pipeline 112 and/or other audio processing of the audio data 106 received from the one or more audio capture devices 102.

In some examples, the AV processing apparatus 202 includes the input/output circuitry 212 that may, in turn, be in communication with processor 204 to provide output to the user and, in some examples, to receive an indication of a user input. The input/output circuitry 212 may comprise a user interface and may comprise a display. In some examples, the input/output circuitry 212 may also comprise a keyboard, a touch screen, touch areas, soft keys, buttons, knobs, or other input/output mechanisms.

In some examples, the AV processing apparatus 202 includes the communications circuitry 214. The communications circuitry 214 may be any means embodied in either hardware or a combination of hardware and software that is configured to receive and/or transmit data from/to a network and/or any other device or module in communication with the AV processing apparatus 202. In this regard, the communications circuitry 214 may comprise, for example, an antenna or one or more other communication devices for enabling communications with a wired or wireless communication network. For example, the communications circuitry 214 may comprise antennae, one or more network interface cards, buses, switches, routers, modems, and supporting hardware and/or software, or any other device suitable for enabling communications via a network. Additionally or alternatively, the communications circuitry 214 may comprise the circuitry for interacting with the antenna/antennae to cause transmission of signals via the antenna/antennae or to handle receipt of signals received via the antenna/antennae.

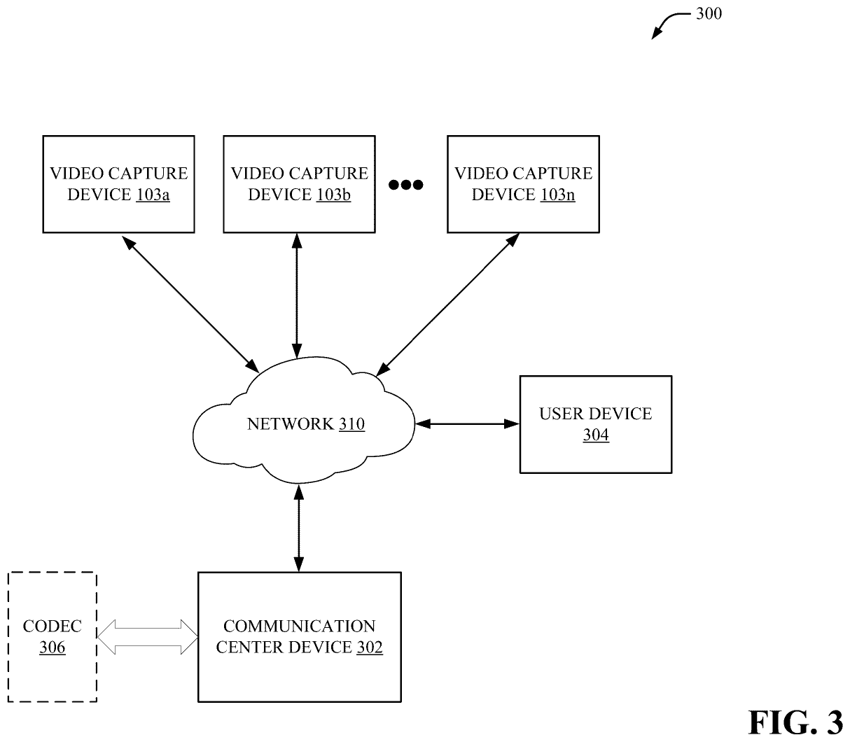

FIG. 3 illustrates a network system 300 according to one or more embodiments of the present disclosure. The network system 300 includes the one or more video capture devices 103 (e.g., video capture devices 103a-n), a communication center device 302, and/or a user device 304. The one or more video capture devices 103 may respectively provide a video stream (e.g., the video data 105) related to a video environment. The one or more video capture devices 103 may additionally provide metadata related to the respective video stream. In some examples, the one or more video processors 103, the communication center device 302, and/or the user device 304 may be communicatively coupled via a network 310. The network 310 may include one or more network devices such as one or more network switches and/or one or more network routers. The communication center device 302 may be a hub device that supports Ethernet, voice over Internet Protocol (VOIP), and/or one or more network communication protocols. In some examples, the communication center device 302 may enable the one or more video processors 103 to be configured as a set of network-connected video devices for a video environment. Alternatively, the one or more video processors 103 and/or the user device 304 may be directly coupled to the communication center device 302 without utilization of the network 310. In some examples, the communication center device 302 includes the AV processing system 104.

The communication center device 302 may provide video and/or audio from the one or more video capture devices 103 to the user device 304. For instance, the communication center device 302 may provide the encoded video data 114 to the user device 304. In some examples, the user device 304 may be configured as a host device for a video conference enabled by the one or more video processors 103 and the communication center device 302. For instance, the user device 304 may be configured as a host of a codec 306 that receives a video stream (e.g., the encoded video data 114) provided by the one or more video capture device 103. In some examples, the codec 306 is a video conference codec configured for video conferencing. The user device 304 may be communicatively coupled to the communication center device 302 via the internet or another direct IP connection. Alternatively, the user device 304 may be communicatively coupled to the communication center device 302 via a direct wired connection such as a USB connection or another type of hardware interface that supports a display protocol.

The user device 304 may be a smartphone, a laptop, a personal computer, a digital conference device, a wireless conference unit, an augmented reality device, a virtual reality device, or another type of user device. In some examples, the user device 304 includes a display and/or a graphical user interface that renders video content provided by the one or more video capture devices 103. In some examples, the user device 304 may provide a virtual video capture device and/or a virtual audio capture device for the network system 300. Additionally, video and/or audio from the virtual devices may be routed to the codec 306 in addition to video and/or audio from one or more video capture devices 103.

In some examples, the user device 304 may provide user device data to the communication center device 302 and/or the one or more video capture devices 103 to enable interactions with the communication center device 402 and/or the one or more video capture devices 103. The user device data may include data such as, but not limited to: supported video formats, network interface card (NIC) bandwidth, a role identifier (e.g., hub or video capture device), a device identifier (e.g., a media access control (MAC) address or another type of identifier), a user identifier, and/or other data related to the user device 304. In some examples, one or more portions of the user device data may be provided via an electronic interface of the user device 304. Additionally or alternatively, one or more portions of the user device data may be provided via metadata or a user device profile for the user device 304.

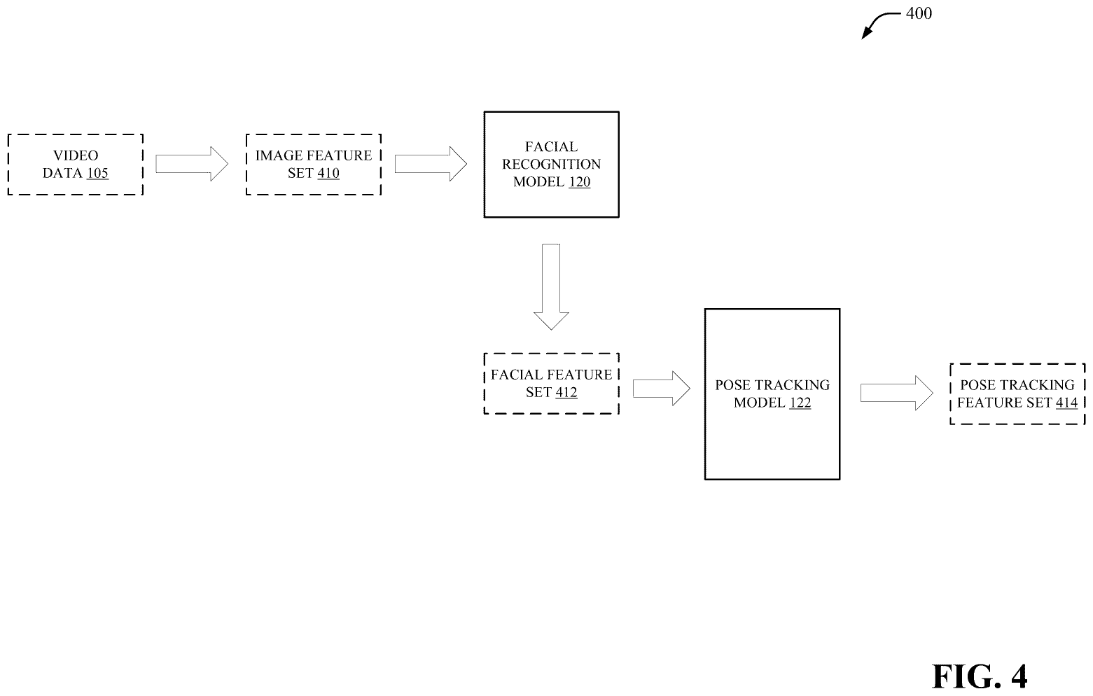

FIG. 4 illustrates a facial recognition and pose tracking architecture 400 according to one or more embodiments of the present disclosure. The facial recognition and pose tracking architecture 400 may be related to functionality provided by the facial recognition engine 109 and the pose tracking engine 110. The facial recognition and pose tracking architecture 400 includes the facial recognition model 120 and the pose tracking model 122. In some examples, the facial recognition engine 109 may extract an image feature set 410 from the video data 105. The image feature set 410 may include one or more image features related to the video data 105 such as, but not limited to: pixel information, pixel intensity, color information, color histograms, edge detection information, shape descriptors, texture descriptors, and/or other image information. In some examples, the facial recognition engine 109 may be implemented on a video capture device (e.g., the video capture devise 103) or a device connected to a video capture device to provide the feature extraction related to the image feature set 410. In some examples, the video data 105 and the image feature set 410 may be transmitted via the network 310 and/or received by the communication center device 302.

Additionally, the facial recognition engine 109 may input the image feature set 410 to the facial recognition model 120 to generate a facial feature set 412. The facial feature set 412 may be related to a target of interest correlated with a facial identifier. The facial feature set 412 may include one or more facial features such as, but not limited to: a facial identifier that corresponds to a tracked face, bounding box coordinates of a tracked face (e.g., left, right, top and bottom coordinates), a match count corresponding to a total amount of times a face has been matched over time, last seen image information corresponding to extracted imagery of a last time a tracked face has been matched, last matched frame information corresponding to a video frame number of the last time the tracked face was matched, and/or other facial information.

The pose tracking engine 110 may input at least a portion of the facial feature set 412 into the pose tracking model 122 to generate a pose tracking feature set 414. In some examples, the pose tracking model 122 may utilize an augmented version of the bounding box coordinates of the tracked face to generate the pose tracking feature set 414. The augmented version of the bounding box coordinates may include modified left, right, and/or bottom coordinates to capture bounding box coordinates of a body corresponding to the tracked face. In some examples, the augmented version of the bounding box coordinates may be a result of an expansion of the left, right, and/or bottom coordinates. In some examples, the pose tracking engine 110 may select a bounding box from a plurality of bounding boxes in at least one video frame to provide one or more pose tracking features for the selected bounding box. The selected bounding box may be related to a previously identified target of interest and/or a previous pose tracking in one or more previous video frames. Alternatively, the selected bounding box may be deemed a most likely primary target of interest in the at least one video frame. However, it is to be appreciated that the selected bounding box may be selected from the plurality of bounding box using one or more other techniques. The pose tracking feature set 414 may include one or more pose tracking features such as, but not limited to: bounding box coordinates of a tracked body (e.g., left, right, top and bottom coordinates), head pose features, head pose angles, body pose features, body pose angles, last frame information corresponding to a last video frame that the pose information was last updated, and/or other pose tracking information.

By utilizing the facial feature set 412, the pose tracking model 122 may provide the pose tracking feature set 414 with improved accuracy and/or by minimizing a number of computing resources. For example, in contrast to a traditional AV conferencing system that typically provides the image feature set 410 as input to the pose tracking model 122, the pose tracking model 122 may receive the facial feature set 412 as input to intelligently and/or optimally locate a body portion of the target of interest using the facial feature set 412 as a reference to a location of the body portion proximate to the face portion.

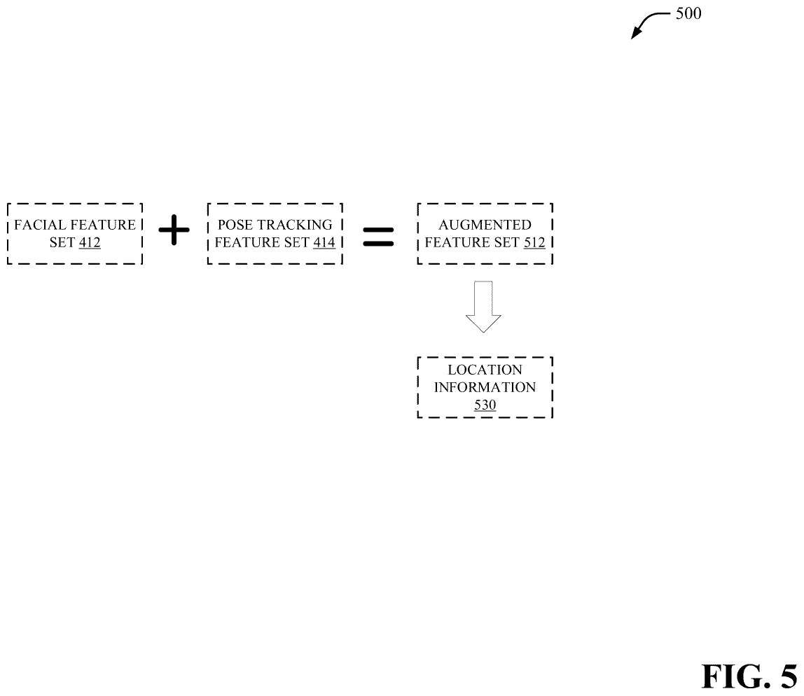

FIG. 5 illustrates a feature augmentation architecture 500 according to one or more embodiments of the present disclosure. The feature augmentation architecture 500 may be related to functionality provided by the facial recognition engine 109 and/or the pose tracking engine 110. With the feature augmentation architecture 500, the pose tracking engine 110 may augment the facial feature set 412 with the pose tracking feature set 414 to generate an augmented feature set 512 for the facial identifier associated with the facial recognition model 120. The augmented feature set 512 may include a more accurate facial prediction for the target of interest as compared to the facial feature set 412. Additionally, the video pipeline engine 111 may utilize the augmented feature set 512 to determine location information 530 for the facial identifier. The augmented feature set 512 may include one or more features of the facial feature set 412 and one or more features of the pose tracking feature set 414. In some examples, the augmented feature set 512 may include at least facial keypoints related to the facial feature set 412 and body keypoints related to the pose tracking feature set 414. The location information 530 may indicate a tracked location of the target of interest associated with the facial identifier. In some examples, the location information 530 includes a bounding box related to the augmented feature set 512. In some examples, the location information 530 (e.g., the bounding box related to the augmented feature set 512) may be utilized to track the target of interest in one or more future video frames.

In some examples, the augmented feature set 512 may be compared to a predetermined representation of the target of interest via normalized correlation matching to generate a similarity score for the augmented feature set 512. Additionally, the location information 530 may be output based on the similarity score. In some examples, a list of tracked faces for respective video frames in video data (e.g., the video data 105) may be updated based on the location information 530. In some examples, the augmented feature set 512 may be provided as input to a facial similarity model to determine an accuracy metric score for the augmented facial feature 512. In some examples, the augmented feature set 512 may be provided as input to a Kalman filter model to provide a movement prediction in a video environment for the target of interest.

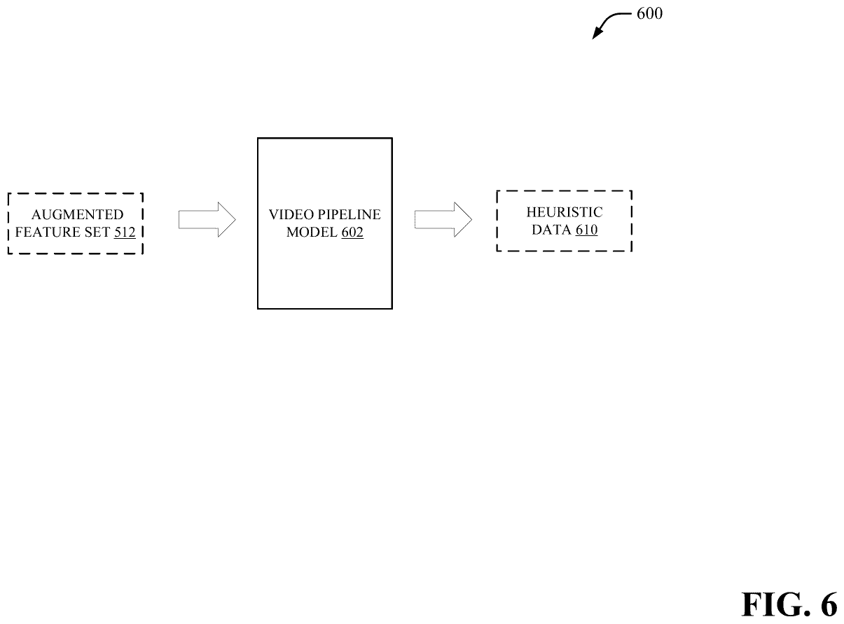

FIG. 6 illustrates a video optimization architecture 600 according to one or more embodiments of the present disclosure. The video optimization architecture 600 may be related to functionality provided by the video pipeline engine 111. The video optimization architecture 600 includes a video pipeline model 602. The video pipeline model 602 may be a machine learning model that provides heuristic data 610 related to the video data 105 based on the augmented feature set 512. In some examples, the video pipeline model 602 may be configured as a neural network model, a deep learning model, a convolutional neural network model, and/or another type of machine learning models. The heuristic data 610 may include predictions and/or metrics related to the augmented feature set 512.

In some examples, the video pipeline model 602 is a facial similarity model that determines accuracy metrics related to the video data 105. For example, the video pipeline engine 111 may input the augmented feature set 512 into the video pipeline model 602 to determine accuracy of the facial prediction and/or the pose tracking prediction provided by the facial recognition model 120 and/or the pose tracking model 122. The video pipeline model 602 may provide the facial similarity prediction via cross-correlation, re-identification, machine learning, and/or one or more other similarity measure techniques.

In some examples, the video pipeline model 602 is a Kalman filter model that provides movement predictions for the target of interest related to the augmented feature set 512. For example, the video pipeline engine 111 may input the augmented feature set 512 into the video pipeline model 602 to determine one or more location predictions for the target of interest in the video environment.

In some examples, the video pipeline model 602 is a cross correlation model that provides a similarity score between the target of interest related to the augmented feature set 512 and one or more previously identified persons of interest. For example, the video pipeline engine 111 may input the augmented feature set 512 into the video pipeline model 602 to determine a similarity score between the facial identifier related to the augmented feature set 512 and one or more facial identifiers stored in a track list for the video environment.

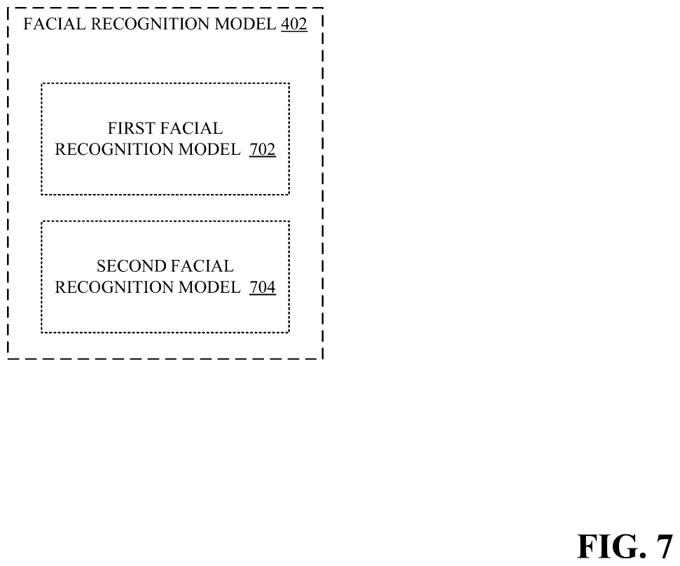

FIG. 7 illustrates the facial recognition model 402 according to one or more embodiments of the present disclosure. In some examples, the facial recognition model 402 includes a first facial recognition model 702 and a second facial recognition model 704. The first facial recognition model 702 may be different than the second facial recognition model 704. For example, the first facial recognition model 702 may be configured for higher accuracy with slower computing speed for facial recognition as compared to the second facial recognition model 704. As such, the second facial recognition model 704 may be updated more frequently than the first facial recognition model 702. Additionally or alternatively, the second facial recognition model 704 may output a greater number of features (e.g., a greater number of keypoints related to a target of interest) than the first facial recognition model 702 during a particular interval of time. In some examples, the first facial recognition model 704 is a multi-task cascaded convolutional neural network (MTCNN) configured for facial recognition and the second facial recognition model 704 is a transfer learning model configured for facial recognition. In some examples, the first facial recognition model 702 and the second facial recognition model 704 may be executed in parallel. Additionally, the first facial recognition model 702 and the second facial recognition model 704 may respectively provide one or more portions of the facial feature set 412 to the pose tracking model 122 to allow the pose tracking model 122 to repeatedly update one or more portions of the pose tracking feature set 414 during the parallel execution of the first facial recognition model 702 and the second facial recognition model 704.

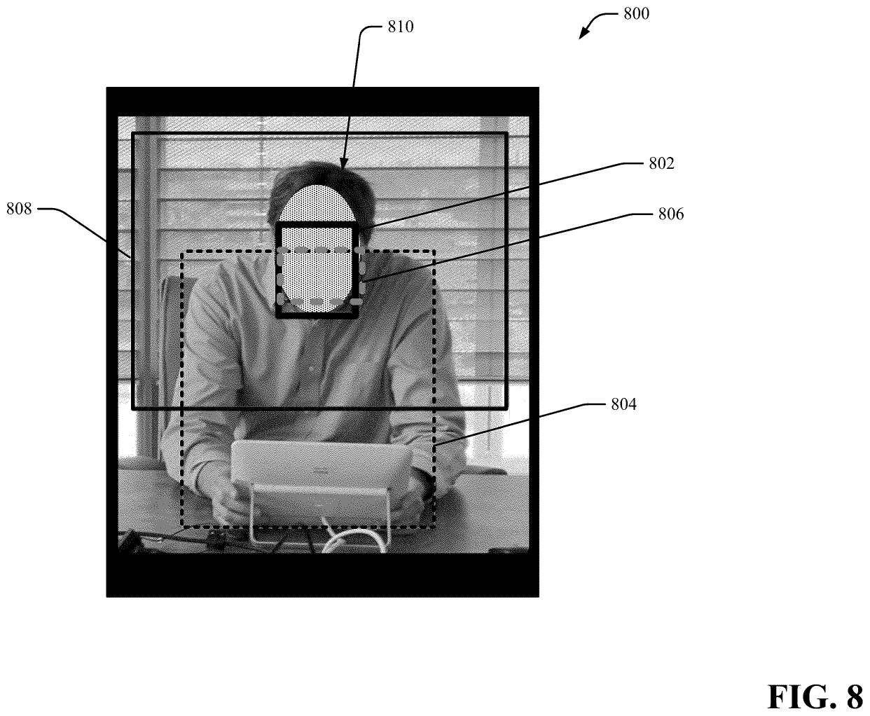

FIG. 8 illustrates a video frame 800 according to one or more embodiments of the present disclosure. The video frame 800 may be a video frame of the video data 105. The video frame 800 includes bounding box information provided by the facial feature set 412, the pose tracking feature set 414, the augmented feature set 512, and/or the location information 530. For example, the video frame 800 includes a bounding box 802 corresponding to a bounding box included in the augmented feature set 512, a bounding box 804 corresponding to a bounding box included in the pose tracking feature set 414 (e.g., as provided by the pose tracking model 122), a bounding box 806 corresponding to a bounding box included in the facial feature set 412 (e.g., as provided by the facial recognition model 120), and a bounding box 808 corresponding to a bounding box included in the location information 530. The bounding box 808 may represent a search area in which a face for a target of interest may be located within for one or more future video frames during a next timestep of video data after the video frame 800.

In some examples, the bounding box 808 may be an expanded version of the bounding box 802. For instance, width and/or height of the bounding box 802 may be expanded to provide the bounding box 808. In some examples, the bounding box 802 and/or the bounding box 808 may be utilized for location tracking within video frames of video data. The video frames related to the location tracking may include the video frame 800 and/or one or more future video frames within a next timestep of video data such as, for example, the video data 105. Accordingly, improved location tracking for a target of interest 810 in the video frame 800 and/or one or more future video frames within a next timestep of video data may be provided.

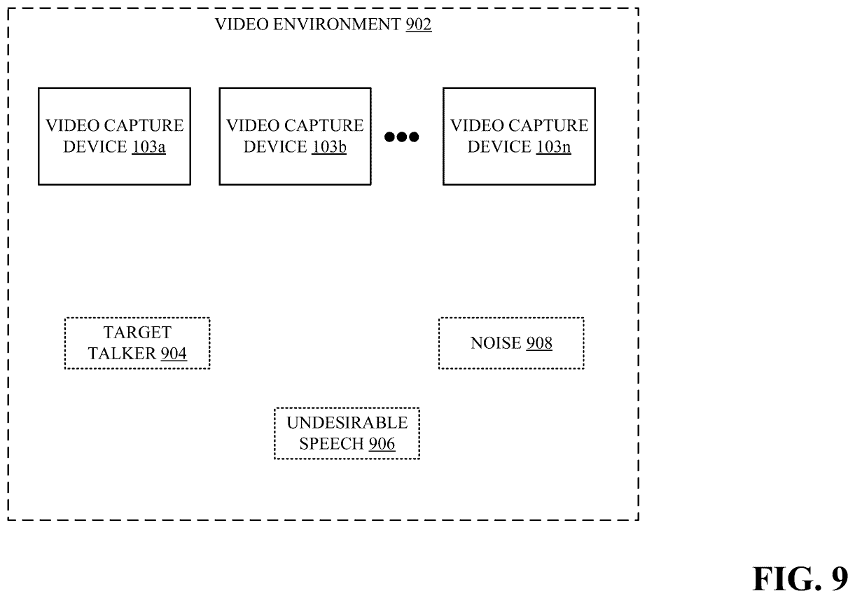

FIG. 9 illustrates an example video environment 902 according to one or more embodiments of the present disclosure. The video environment 902 may be an indoor environment, an outdoor environment, an entertainment environment, a room, a classroom, a lecture hall, a performance hall, a broadcasting environment, a sports stadium or arena, a virtual environment, an automobile environment, or another type of video environment. The video environment 902 includes at least the one or more video capture devices 103a-n that are respectively capable of capturing video and/or audio from one or more sources and/or other audio in the video environment 902. For example, the one or more video capture devices 103a-n 102 may capture video and/or audio (e.g., the video data 105 and/or the audio data 106) associated with a target talker 904, undesirable speech 906, and/or noise 908 in the video environment 902. In some examples, the one or more video capture devices 103a-n recognize the target talker 904, modifies a video capture process, and/or steers one or more audio beams based on the location information 530.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

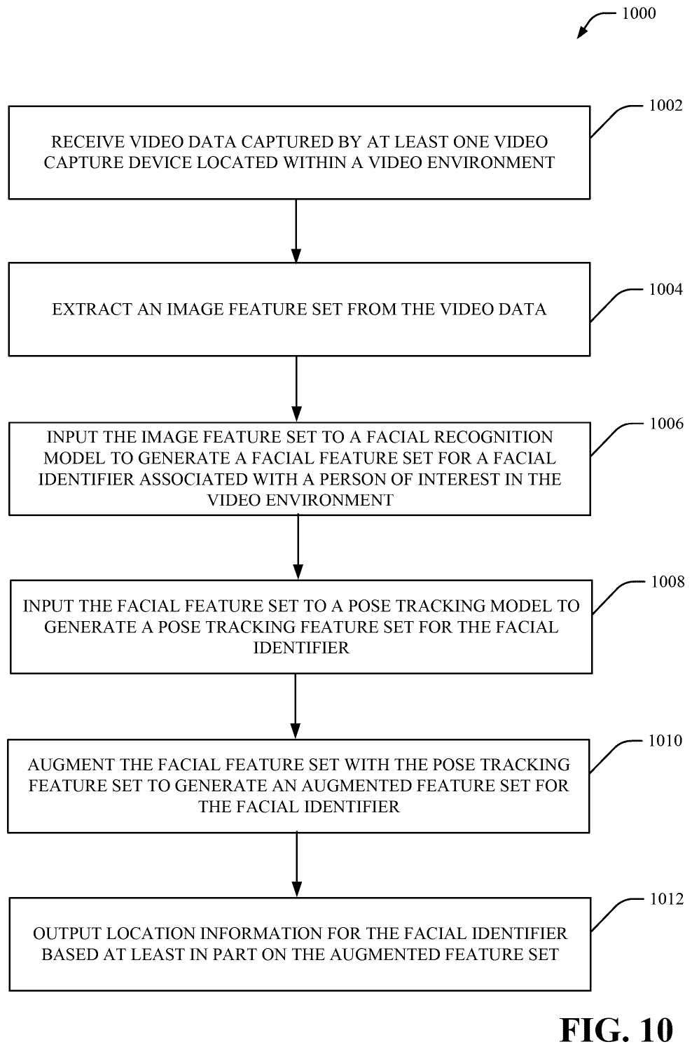

FIG. 10 is a flowchart diagram of an example process 1000 for providing video content processing based on facial recognition and pose tracking modeling, in accordance with, for example, the AV processing apparatus 202 illustrated in FIG. 2. Via the various operations of the process 1000, the AV processing apparatus 202 may enhance quality, reliability, and/or source separation of video data for rendering via a display interface.

The process 1000 begins at operation 1002 that receives (e.g., by the machine learning circuitry 207) video data captured by at least one video capture device located within a video environment. The video data may include one or more video frames. The video environment may be an indoor environment, an outdoor environment, an entertainment environment, a room, a classroom, a lecture hall, a performance hall, a broadcasting environment, a sports stadium or arena, a virtual environment, an automobile environment, or another type of video environment.

The process 1000 also includes an operation 1004 that extracts (e.g., by the machine learning circuitry 207) an image feature set from the video data. The image feature set may include one or more image features related to the video data such as, but not limited to: pixel information, pixel intensity, color information, color histograms, edge detection information, shape descriptors, texture descriptors, and/or other image information.

The process 1000 also includes an operation 1006 that inputs (e.g., by the machine learning circuitry 207) the image feature set to a facial recognition model to generate a facial feature set for a facial identifier associated with a target of interest in the video environment. The facial feature set may include one or more facial features such as, but not limited to: a facial identifier that corresponds to a tracked face, bounding box coordinates of a tracked face (e.g., left, right, top and bottom coordinates), a match count corresponding to a total amount of times a face has been matched over time, last seen image information corresponding to extracted imagery of a last time a tracked face has been matched, last matched frame information corresponding to a video frame number of the last time the tracked face was matched, and/or other facial information. In some examples, the facial recognition model includes an MTCNN configured for facial recognition and a transfer learning model configured for facial recognition.

The process 1000 also includes an operation 1008 that inputs (e.g., by the machine learning circuitry 207) the facial feature set to a pose tracking model to generate a pose tracking feature set for the facial identifier. The pose tracking feature set may include one or more pose tracking features such as, but not limited to: bounding box coordinates of a tracked body (e.g., left, right, top and bottom coordinates), head pose features, head pose angles, body pose features, body pose angles, last frame information corresponding to a last video frame that the pose information was last updated, and/or other pose tracking information.

The process 1000 also includes an operation 1010 that augments (e.g., by the machine learning circuitry 207 and/or the video processing circuitry 208) the facial feature set with the pose tracking feature set to generate an augmented feature set for the facial identifier. The augmented feature set may include a more accurate facial prediction for the target of interest as compared to the facial feature set. The augmented feature set may include one or more features of the facial feature set and one or more features of the pose tracking feature set. In some examples, the augmented feature set may include at least facial keypoints related to the facial feature set and body keypoints related to the pose tracking feature set.

The process 1000 also includes an operation 1012 that outputs (e.g., by the machine learning circuitry 207 and/or the video processing circuitry 208) output location information for the facial identifier based at least in part on the augmented feature set. For example, the augmented feature set may be utilized to determine location information for the facial identifier. In some examples, the location information includes a bounding box related to the augmented feature set. In some examples, the bounding box of the location information is an expanded version of a bonding box related to the augmented feature set. In some examples, the location information may be utilized to track a target of interest related to the facial feature set in one or more future video frames.

In some examples, the process 1000 additionally or alternatively includes an operation that modifies (e.g., by the video processing circuitry 208) video framing of the least one video capture device based at least in part on the location information.

In some examples, the process 1000 additionally or alternatively includes an operation that generates (e.g., by the machine learning circuitry 207 and/or the video processing circuitry 208) input data for a machine learning model based at least in part on the location information.

In some examples, the process 1000 additionally or alternatively includes an operation that steers (e.g., by the audio processing circuitry 210) a microphone array beam for an audio capture device in the video environment based at least in part on the location information.

In some examples, the process 1000 additionally or alternatively includes an operation that performs (e.g., by the audio processing circuitry 210) source separation for audio data related to the video data based at least in part on the location information.

In some examples, the process 1000 additionally or alternatively includes an operation that selects (e.g., by the video processing circuitry 208) a video capture device in the video environment for outputting a video stream associated with the facial identifier based at least in part on the location information.

In some examples, the process 1000 additionally or alternatively includes an operation that generates (e.g., by the machine learning circuitry 207) a 3D model of the video environment based at least in part on the location information.

In some examples, the process 1000 additionally or alternatively includes an operation that inputs (e.g., by the machine learning circuitry 207) the augmented feature set to a facial similarity model to determine an accuracy metric score for the augmented facial feature.

In some examples, the process 1000 additionally or alternatively includes an operation that compares (e.g., by the machine learning circuitry 207 and/or the video processing circuitry 208) the augmented feature set to a predetermined representation of the target of interest via normalized correlation matching to generate a similarity score for the augmented feature set. In some examples, the process 1000 additionally or alternatively includes an operation that outputs (e.g., by the machine learning circuitry 207 and/or the video processing circuitry 208) the location information based at least in part on the similarity score.

In some examples, the process 1000 additionally or alternatively includes an operation that inputs (e.g., by the machine learning circuitry 207 and/or the video processing circuitry 208) the augmented feature set to a Kalman filter model to provide a movement prediction for one or more future video frames related to the video environment for the target of interest.

In some examples, the process 1000 additionally or alternatively includes an operation that updates (e.g., by the machine learning circuitry 207 and/or the video processing circuitry 208) a list of tracked faces for respective video frames in the video data based at least in part on the location information.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, engine, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the disclosure or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the processor, to cause the apparatus to: receive video data captured by at least one video capture device located within a video environment.

Clause 2. The apparatus of clause 1, wherein the instructions are further operable to cause the apparatus to: extract an image feature set from the video data.

Clause 3. The apparatus of any one of the foregoing clauses, wherein the instructions are further operable to cause the apparatus to: input the image feature set to a facial recognition model to generate a facial feature set for a facial identifier associated with a target of interest in the video environment.

Clause 4. The apparatus of any one of the foregoing clauses, wherein the instructions are further operable to cause the apparatus to: input the facial feature set to a pose tracking model to generate a pose tracking feature set for the facial identifier.

Clause 5. The apparatus of any one of the foregoing clauses, wherein the instructions are further operable to cause the apparatus to: augment the facial feature set with the pose tracking feature set to generate an augmented feature set for the facial identifier.

Clause 6. The apparatus of any one of the foregoing clauses, wherein the instructions are further operable to cause the apparatus to: output location information for the facial identifier based at least in part on the augmented feature set.

Clause 7. The apparatus of any one of the foregoing clauses, wherein the instructions are further operable to cause the apparatus to: modify video framing of the least one video capture device based at least in part on the location information.

Clause 8. The apparatus of any one of the foregoing clauses, wherein the instructions are further operable to cause the apparatus to: generate input data for a machine learning model based at least in part on the location information.

Clause 9. The apparatus of any one of the foregoing clauses, wherein the instructions are further operable to cause the apparatus to: steer a microphone array beam for an audio capture device in the video environment based at least in part on the location information.

Clause 10. The apparatus of any one of the foregoing clauses, wherein the instructions are further operable to cause the apparatus to: perform source separation for audio data related to the video data based at least in part on the location information.

Clause 11. The apparatus of any one of the foregoing clauses, wherein the instructions are further operable to cause the apparatus to: select a video capture device in the video environment for outputting a video stream associated with the facial identifier based at least in part on the location information.

Clause 12. The apparatus of any one of the foregoing clauses, wherein the instructions are further operable to cause the apparatus to: generate a three-dimensional (3D) model of the video environment based at least in part on the location information.

Clause 13. The apparatus of any one of the foregoing clauses, wherein the instructions are further operable to cause the apparatus to: input the augmented feature set to a facial similarity model to determine an accuracy metric score for the augmented facial feature.

Clause 14. The apparatus of any one of the foregoing clauses, wherein the instructions are further operable to cause the apparatus to: compare the augmented feature set to a predetermined representation of the target of interest via normalized correlation matching to generate a similarity score for the augmented feature set.

Clause 15. The apparatus of any one of the foregoing clauses, wherein the instructions are further operable to cause the apparatus to: output the location information based at least in part on the similarity score.

Clause 16. The apparatus of any one of the foregoing clauses, wherein the instructions are further operable to cause the apparatus to: input the augmented feature set to a Kalman filter model to provide a movement prediction in the video environment for the target of interest.

Clause 17. The apparatus of any one of the foregoing clauses, wherein the instructions are further operable to cause the apparatus to: update a list of tracked faces for respective video frames in the video data based at least in part on the location information.

Clause 18. The apparatus of any one of the foregoing clauses, wherein the facial recognition model includes a multi-task cascaded convolutional neural network (MTCNN) configured for facial recognition and a transfer learning model configured for facial recognition.

Clause 19. A computer-implemented method comprising steps in accordance with any one of the foregoing clauses.

Clause 20. A computer program product, stored on a computer readable medium, comprising instructions that, when executed by one or more processors of the audio signal processing apparatus, cause the one or more processors to perform one or more operations related to any one of the foregoing clauses.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. An apparatus comprising at least one processor and a memory storing instructions that are operable, when executed by the processor, to cause the apparatus to:
receive video data captured by at least one video capture device located within a video environment;
extract an image feature set from the video data;
input the image feature set to a facial recognition model to generate a facial feature set for a facial identifier associated with a target of interest in the video environment;
input the facial feature set to a pose tracking model to generate a pose tracking feature set for the facial identifier;
augment the facial feature set with the pose tracking feature set to generate an augmented feature set for the facial identifier; and
output location information for the facial identifier based at least in part on the augmented feature set.

2. The apparatus of claim 1, wherein the instructions are further operable to cause the apparatus to:
modify video framing of the least one video capture device based at least in part on the location information.

3. The apparatus of claim 1, wherein the instructions are further operable to cause the apparatus to:
generate input data for a machine learning model based at least in part on the location information.

4. The apparatus of claim 1, wherein the instructions are further operable to cause the apparatus to:
steer a microphone array beam for an audio capture device in the video environment based at least in part on the location information.

5. The apparatus of claim 1, wherein the instructions are further operable to cause the apparatus to:
perform source separation for audio data related to the video data based at least in part on the location information.

6. The apparatus of claim 1, wherein the instructions are further operable to cause the apparatus to:
select a video capture device in the video environment for outputting a video stream associated with the facial identifier based at least in part on the location information.

7. The apparatus of claim 1, wherein the instructions are further operable to cause the apparatus to:
generate a three-dimensional (3D) model of the video environment based at least in part on the location information.

8. The apparatus of claim 1, wherein the instructions are further operable to cause the apparatus to:
input the augmented feature set to a facial similarity model to determine an accuracy metric score for the augmented facial feature.

9. The apparatus of claim 1, wherein the instructions are further operable to cause the apparatus to:
compare the augmented feature set to a predetermined representation of the target of interest via normalized correlation matching to generate a similarity score for the augmented feature set; and
output the location information based at least in part on the similarity score.

10. The apparatus of claim 1, wherein the instructions are further operable to cause the apparatus to:
input the augmented feature set to a Kalman filter model to provide a movement prediction in the video environment for the target of interest.

11. The apparatus of claim 1, wherein the instructions are further operable to cause the apparatus to:
update a list of tracked faces for respective video frames in the video data based at least in part on the location information.

12. The apparatus of claim 1, wherein the facial recognition model includes a multi-task cascaded convolutional neural network (MTCNN) configured for facial recognition and a transfer learning model configured for facial recognition.

13. A computer-implemented method comprising:
receiving video data captured by at least one video capture device located within a video environment;
extracting an image feature set from the video data;
inputting the image feature set to a facial recognition model to generate a facial feature set for a facial identifier associated with a target of interest in the video environment;
inputting the facial feature set to a pose tracking model to generate a pose tracking feature set for the facial identifier;
augmenting the facial feature set with the pose tracking feature set to generate an augmented feature set for the facial identifier; and
outputting location information for the facial identifier based at least in part on the augmented feature set.

14. The computer-implemented method of claim 13, further comprising:
modifying video framing of the least one video capture device based at least in part on the location information.

15. The computer-implemented method of claim 13, further comprising:
generating input data for a machine learning model based at least in part on the location information.

16. The computer-implemented method of claim 13, further comprising:
steering a microphone array beam for an audio capture device in the video environment based at least in part on the location information.

17. The computer-implemented method of claim 13, further comprising:
performing source separation for audio data related to the video data based at least in part on the location information.

18. The computer-implemented method of claim 13, further comprising:
selecting a video capture device in the video environment for outputting a video stream associated with the facial identifier based at least in part on the location information.

19. The computer-implemented method of claim 13, further comprising:
generating a three-dimensional (3D) model of the video environment based at least in part on the location information.

20. A computer program product, stored on a computer readable medium, comprising instructions that, when executed by one or more processors of an apparatus, cause the one or more processors to:
receive video data captured by at least one video capture device located within a video environment;
extract an image feature set from the video data;
input the image feature set to a facial recognition model to generate a facial feature set for a facial identifier associated with a target of interest in the video environment;
input the facial feature set to a pose tracking model to generate a pose tracking feature set for the facial identifier;
augment the facial feature set with the pose tracking feature set to generate an augmented feature set for the facial identifier; and
output location information for the facial identifier based at least in part on the augmented feature set.
